(19) United States
(12) Patent Application Publication
(10) Pub. No.: US 2010/0142692 A1
(43) Pub. Date: Jun. 10, 2010

(54) Method and system for providing teleassistance services based on software agents executing workflows

(75) Inventors: Danilo Gotta, Torino (IT); Marco Ughetti, Torino (IT); Domenico Enrico Bena, Torino (IT); Giovanni Dona, Torino (IT); Tiziana Trucco, Torino (IT); Giovanna Larini, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TELECOM ITALIA S.p.A.

(21) Appl. No.: 12/448,353

(22) PCT Filed: Dec. 19, 2006
(86) PCT No.: PCT/IB2006/003710

§ 371 Date: Feb. 24, 2010

(51) Int. Cl. H04M 3/42

(52) U.S. Cl. 379/201.02

(57) ABSTRACT

A system for performing a teleassistance service, for example, in the medical field, comprising a central system for controlling and managing the service, a local system for performing the service, and a telecommunication network adapted to communicate the central system with the local system, wherein the local system includes at least one sensor adapted to perform measures of at least one biomedical parameter on a user and a terminal adapted to communicate with the sensor for receiving information related to measure results and adapted to transmit said information to the central system through the telecommunications network, and wherein at least one between the terminal and the central system includes a software agent provided with a process engine for executing workflows, said agent being adapted to interact with the sensor when executing workflows.

### TECHNICAL FIELD OF THE INVENTION

The present invention is related to a method and a system for performing teleassistance services for applications linked to health and wellness of people, herein below called “healthcare” and “wellness” services.

### PRIOR ART

Healthcare and wellness services have a high complexity in terms of involved actors, apparatuses that can be used and processes underlying the delivery of services.

Nowadays, information systems in healthcare environments are characterised by a high complexity, since they must support the plurality of involved actors, manage numerosity and non-uniformity of used apparatuses, govern services creating and delivering processes, and allow customising the services for all users.

Moreover, in many cases, the evolution of information systems in healthcare environments resulted in the creation of scarcely mutually integrated application islands, even within a single organisation (for example hospital departments and medical first aid stations).

For these reasons, the creation of new services or functionalities is limited in terms of integration with existing solutions, scalability (namely capability of supporting services that can involve a high number of actors) and flexibility (namely capability of responding to different needs that can dynamically occur).

Moreover, nowadays, systems and methods used for healthcare and wellness services are mainly based on solutions with architectures of the client-server type, in which service logic and arrangement are implemented on a centralised software application (server) that coordinates and manages distributed hardware and software resources (client).

In literature there are also some solutions based on Agent Systems or Multi Agent Systems (MAS). Such solutions use distributed architectures with different types of software agents to which defined roles and tasks are assigned. Service logic and arrangement are demanded to the specific programming of a component (for example being itself an agent) whose tasks are activating, controlling and administering architecture agents in order to reach the service objective.

Some solutions analysed in the prior art use, in addition to agents, also “workflows”. In such case, agents' roles and tasks are predefined depending on initial design and their programming (for example “chronic patient agents” or “medical agents” are defined). The workflow component is used for assigning in a centralised way tasks and objectives to agents depending on their pre-defined behaviour.

Herein below some known teleassistance solutions are mentioned.

US2006/0089853A1 is related to a system and a method for allowing users to communicate and share data with service providers, focusing their attention on the case in which users are patients and service providers are Health Care Professionals (HCP) and the system is used for remote health care monitoring. The solution key points are:

a method for generating clinical protocols, comprising the steps that the patient must perform by selecting generic clinical protocols, which must be specialised for the particular clinical case by the professionals;

a method for sharing data between customers and the plurality of professionals by subscribing data related to related patient's clinical protocols;

a method for transmitting the protocol to the patient's apparatus and for locally executing it through a “bootstrap”;

an editor for generating generic protocols that are stored in a dedicated “protocol memory”.

Articles L. M. Camarinha-Matos and H. Afsarmanesh, “TeleCARE: Collaborative virtual elderly support communities”, in Proceedings of the 1st Workshop on Tele-Care and Collaborative Virtual Communities in Elderly Care, TELECARE 2004, and L. M. Camarinha-Matos, Joao Rosas, Ana-Ines Oliveira, “A Mobile Agents Platform for Telecare and Teleassistance”, in Proceedings of the 1st Workshop on Tele-Care and Collaborative Virtual Communities in Elderly Care, TELECARE 2004, describe a system (called Telecare) comprising a platform (framework) for creating and delivering eHealth services dedicated to elderly people and virtual communities of elderly people.

Such platform is based on using stationary agents and mobile agents; the MAS (Multi Agent System) platform provides methods and tools for creating, transmitting, receiving, authenticating, validating, executing and interacting with agents, and also perform the management of health data and system information (catalogue of devices and services). Moreover, every specific service is implemented by using, in different ways, a set of stationary and mobile agents.

Article Mihaela Ulieru (Electrical and Computer Engineering Department, The University of Calgary), “Internet-enabled soft computing holarchies for e-health applications—Soft Computing Enhancing the Internet and the Internet Enhancing Soft Computing”, available on http://isg.enme.ucalgary.ca/People/Ulieru/Default.htm site, proposes an extension of the holarchy paradigm (hierarchic system of entities that can mutually cooperate) from company to health environments. Holarchies in health environment are a system of health entities (ex. patients, doctors, medical devices, hospitals, pharmacies, etc.) that work together for realising services. The proposal provides for implementing “holons” through agents, and the concept of mediator agent is introduced for managing the fact that an entity can in turn be composed of other entities. Moreover, a fuzzy-evolutionary approach is introduced, through which the different entities are organised in order to make clusters of entities and new iteration modes emerge, through which the objective to be reached is better confronted (ex. request of diagnosis by the patient). This ensures that the holarchy goal is reached by reaching the sub-goals of individual entities. This article shows two alternative implementations of medical holarchy. In the first one, dominion actors are realised through web-services and dominion functions are mapped in individual methods stated by the related web-service. The mediator role is performed by a centralised workflow manager (web services manager). In the second one, dominion actors and mediator are realised through software agents with FIPA specification. In this case it is the mediator that manages interactions between agents and not the workflow manager.

Article L. Ardissono, A. Di Leva, G. Petrone, M. Segnan, M. Sonnessa (Dipartimento di Informatica, University di Torino, “Adaptive Medical Workflow Management for a Context-Dependent Home Healthcare Assistance Service”, CWS 2005 Preliminary Version, available on www.di.unito.it/˜liliana/EC/CWS05.pdf Internet site, describes a framework for offering supporting services to actors (patients, doctors, nurses, . . . ) of home health assistance. The home assistance service in general is aimed for elderly and chronic patients, that are usually affected by more than one pathology and must therefore be subjected to more than one medical protocol (depending on the number of pathologies). The proposal provides that actors involved in home assistance service can interact with some computers (desktop, laptop, PDA, . . . ) connected to a network (mobile and/or fixed one).

The proposed framework architecture is based on integrating web services and autonomous agent technologies in order to improve and customise the execution of medical guidelines (treated as abstract workflows) by executing context-based actions. The proposed system allows setting through web different medical guidelines to which a patient must be subjected, the guide to actions that actors (doctors, nurses, patient) must perform to implement the guidelines.

Article David Isern and Antonio Moreno (Departament d'Enginyeria Informàtica i Matemàtiques. Universitat Rovira i Virgili), “Agent-based careflow using CPGs”, available on http://www.etse.urv.es/recerca/rgai/toni/MAS/Publicacions/ccia04dia.pdf site, proposes to use an agent-type platform for managing and coordinating human resources and materials involved in hospital care processes. The proposed system is an evolution of the HeCaSe (Health Care Service) solution, always based on MAS (Multi-Agent System) and described in the previous article. In this solution, all involved actors are modelled through agents implementing individual behaviours and that, by mutually interacting, emulate real processes of a health system. The HeCaSe system allows a patient to have information about services offered by nearest medical centres, to reserve specialist visits through a negotiation process with the chosen doctor. Health personnel has further the chance of flexibly and efficiently organising their own working time, and appointments with patients. Finally, patients' clinical information can be accessed by patients themselves and authorised health personnel that can also update them following a clinical examination or a specialist visit. The main news proposed in this article with respect to the original HeCaSe solution deals with the chance of using agents to help doctors follow the Clinical Practice Guidelines (CPG). The CPG are clinical protocols associated with every single pathology. The objective is that, in the HeCaSe solution, the CPG are automatically embedded in medical and hospital services workflows. In this way, the CPG become part of appointment or services negotiation processes between patients, doctors and health structures. The CPG use a formal language called PROforma that is able to be executed by a computer.

These articles in general integrate the concepts of workflow and autonomous agent in a mode, present in literature, that consists in using the workflows for scheduling single activities/tasks that must then be coded within agents or within web services.

### PURPOSE AND SUMMARY OF THE INVENTION

The Applicant has observed that the previously described known art has the problem of a scarce flexibility and interactivity with users.

For example, in US2006/0089853A1 the only interaction between users and system is through reading/writing information inside pre-established protocols.

In the other cited documents, the individual tasks that agents are able to perform must always be realised through code and implemented at platform design level.

The Applicant has thereby dealt with the problem of providing a particularly functional and interactive teleassistance technique, particularly adapted to also manage situations with scarce capability of users in actively interacting with the system, for example in case of patients with severe illnesses or handicapped.

The Applicant has found that a teleassistance service with such characteristics can be realised by pre-arranging sensors of biomedical parameters to be used by users, and software agents that are able to interact with the sensors during measures execution; such agents are equipped with process engines adapted to execute workflows that implement the chosen teleassistance service logic (every service being defined by one or more workflows), in order to be then able to provide users with information or instructions related with detected parameters. In such a way, it is possible to implement interactive assistance services with procedures for detecting the health status realised through the biomedical sensors. The system can further be integrated with environment sensors and/or with the Telco functionality for locating or detecting the presence of users provided for increasing the assistance service functionality.

The above software agent is preferably loaded in a terminal used by the user or service personnel, and the terminal is able to communicate with the biomedical sensor (namely it is provided with a gateway functionality towards the sensor), for example with a bluetooth connection. The terminal is further able to communicate, through a telecommunications network, with a remote centre (in particular a central system platform), in which the functionalities of creating, storing and deploying the workflows are centralised, in addition to creating and managing the agents. The remote centre can further be interfaced with a services centre, in which specialised personnel can be placed, in turn provided with terminals with agents and workflow engines, for remote diagnosis, monitoring and consultancy activities, always based on data that are locally detected by sensors.

According to a first aspect thereof, the present invention thereby refers to a method for performing a teleassistance service, comprising:

executing a measure of at least one biomedical parameter on a service user;

executing, through a software agent, at least one workflow associated with the service and defining a process interactive with the measure execution.

Advantageously, the method provides for transmitting information related to the result of the measure to a remote system through a telecommunications network.

The method can further provide the user with a feedback based on the result of the measure.

The measure is preferably performed by a sensor used by the user.

The step of transmitting information related to the result of the measure to a remote system can comprise communicating information from the sensor to a terminal and then transmitting information from the terminal to the remote system through the telecommunications network.

The software agent can be in the terminal; alternatively, the software agent can be in the remote system.

The method can further comprise the preliminary steps of defining the workflow in order to implement a service logic, and storing the workflow in a database.

The method can also comprise the steps of receiving a service request by a user, and executing, in reply to the service request, a service activation workflow in a software agent.

Executing an activation workflow can comprise selecting the workflow associated to the service among a plurality of available workflows, depending on information contained in the service request.

Moreover, executing an activation workflow can comprise transmitting the selected workflow to the terminal.

Executing the activation workflow can also comprise configuring the terminal in order to make it suitable for executing the selected workflow.

If the software agent is in the terminal, the step of configuring the terminal can comprise activating the software agent in the terminal and activating a connection between the terminal and the sensor.

Such connection can also be of the bluetooth type.

The method can also comprise the step of executing a measure of at least one environment parameter related to an environment in which the user is located; in such case, the process defined by the workflow can be interactive also with the execution of the measure of the at least one environment parameter.

In addition or alternatively, the method can also comprise the further step of executing a user location measure; in such case, the process defined by the workflow being interactive also with the execution of the location measure.

In a further aspect thereof, the present invention is related to a system for executing a teleassistance service, comprising:

a central service controlling and managing system;

a local service executing system; and

a telecommunication network adapted to communicate the central system with the local system;

wherein the local system comprises at least one sensor adapted to perform measures of at least one biomedical parameter on a user and a terminal adapted to communicate with the sensor for receiving information related to the measure results;

and wherein at least one between the terminal and the central system comprises a software agent provided with a process engine for executing the workflow, said agent being adapted to interact with the sensor when executing the workflow.

Advantageously, the terminal is adapted to transmit information related to measure results to the central system through the telecommunications network.

The terminal can comprise the above agent and a graphic interface through which the user can interact with the workflows.

The terminal can further comprise a device gateway for communicating with the sensor.

The terminal and the sensor can be adapted to mutually communicate through a wireless connection.

Such connection can be of the bluetooth type.

The central system can further comprise a graphic representation system for creating workflows.

The central system can also comprise a data storage system for storing workflows and results of said measures.

Moreover, the central system can comprise a plurality of workflow executing agents, each agent comprising a process engine for executing workflows.

The central system can further comprise adapters for interfacing the plurality of workflow executing agents with the telecommunications network, depending on the used transmission protocol.

Moreover, the central system can comprise a workflow deploying agent. The local system can comprise at least one environment sensor adapted to measure an environment parameter, said agent being adapted to interact with the environment sensor when executing workflows.

The system of the present invention can further comprise a locating system adapted to provide user location information, said agent being adapted to interact with the locating system when executing workflows.

Moreover, the system of the present invention can comprise at least one further terminal adapted to communicate with said terminal through the central system and the telecommunications network.

The above sensor can be integrated in the terminal. The terminal can be a cellular phone.

An important characteristic of the present invention is that the software agent is equipped with a workflow engine that allows it to execute, in a dynamic and flexible way, workflows and subflows (or portions of workflow) that describe the task and the behaviour of the agent for a particular service. Individual agents are therefore able to execute tasks corresponding to portions of workflow, that can be updated through platform provisioning functionalities. In such a way, it is not necessary to program, at design level, the agents by pre-assigning roles and tasks to them. Agents are therefore more open to modify their own behaviour (roles, tasks and activities) depending on what is implemented in the workflow. Moreover, it is possible to quickly create the services since it is enough to implement the service logic inside the workflow and not on various types of distributed agents. The flexibility provided by designing the workflows allows having highly re-usable components and agents and allows configuring the agents also at runtime of processes to be executed.

The use of agents further allows having a computing and decisional capability that is distributed in various system nodes (for example at device or gateway level) and the used workflow solution allows coordinating it. Such aspect allows distributed agents to be autonomous and proactive upon the occurrence of an event and to be able to execute computations or take decisions at system node level. In particular, workflows are arranged for reacting to external events such as the automatic measure of vital patient parameters (ex. pressure, alcohol rate, glycaemia rate, etc.) and communicating in general with the sensors.

The use of the described solution allows having the following further differentiating elements:

definition and giving parameters to the workflows are executed through an evolved editor and provided as functionality to system users (for example medical personnel); it is therefore possible to simply (and also dynamically) define workflows implementing specific services for groups of users or for a single patient;

the system comprises a centralised repository of processes that can be activated (namely executed by agents) on the platform, that can be combined and reused for defining new services;

agents can directly execute a code through their own workflow micro-engine or can be configured with the code to be executed according to needs to be supported/customised;

the workflow is able to react to external events such as, for example, the automatic measure of vital patient parameters, and in general is able to communicate with sensors and medical devices;

it is possible to execute many workflows simultaneously, and the system is able to manage interactions and possible conflicts;

agents can advantageously be distributed on user terminals allowing to execute the service and communication logic with sensors implemented through workflows, by locally exploiting the terminal computation capability;

in order to create clinical protocols through workflows, the xpdl standard is preferably used, that provides for great advantages in terms of documentability and flexibility;

the system has a high degree of scalability since the use of agents and workflows allows having and managing computation and decisional capabilities at node level (distributed intelligence);

it is further possible to use and manage different and heterogeneous apparatuses, devices and gateways, since agents are open to interact with different input and output systems;

the system can further be easily interfaced with already existing solutions in healthcare environments (ex. managing of clinical reports) by using the workflows as explicit and documented mechanism for interaction between systems and information flows communication.

### BRIEF DESCRIPTION OF THE FIGURES

For a better understanding of the present invention, some preferred embodiments of the present invention will be described herein below, with reference in such a description to the enclosed figures, that show the following:

FIG. 1 shows a teleassistance system according to the present invention;

FIG. 2 schematically shows some components of the system in FIG. 1;

FIG. 3 shows a flow diagram related to activating a service that can be delivered by the system in FIG. 1;

FIG. 4 shows a flow diagram related to configuring a service that can be delivered by the system in FIG. 1;

FIG. 5 shows a flow diagram related to a sub-part of the diagram in FIG. 4;

FIG. 6 shows the architecture scenario related to delivering a service through the system of the present invention; and

FIGS. 7 to 11 show flow diagrams related to services that can be delivered by the system of the present invention.

### DETAILED DESCRIPTION OF PREFERRED EMBODIMENTS OF THE PRESENT INVENTION

For the purposes of the present invention, some of its composing elements will be defined below:

Agent: an agent is an autonomous process with an identity, possibly persisting, that requires communication (for example in a cooperating and/or competitive way) with other agents in order to execute the tasks that have been assigned thereto. This communication is implemented through the asynchronous exchange of messages and by using a language (called for example Agent Communication Language—ACL) with a well-defined semantics shared within the platform.

Workflow: a workflow is the partial or total automation of a process, during which information or tasks are passed by a participant to another, in agreement with a set of procedural rules. A workflow can be represented through a flowchart with a sequence of tasks, mutually linked by logic or time dependences such as parallel or alternative paths. There are ad hoc languages, such as XPDL (XML Process Description Language), that allow formally describing the workflows.

Workflow engine: a workflow engine is the component that executes the workflow descriptions, namely that knows all procedures (workflows) with related steps and rules and executes them by determining whether each one of them can advance to the following step.

Sensor: is a device that transforms the physical quantity that has to be acquired into a typically electrical signal.

Device Gateway: it is an interfacing functionality with sensors for communicating patient measures and context information. Such functionality is typically implemented in a mobile or stationary terminal to be used by the patient.

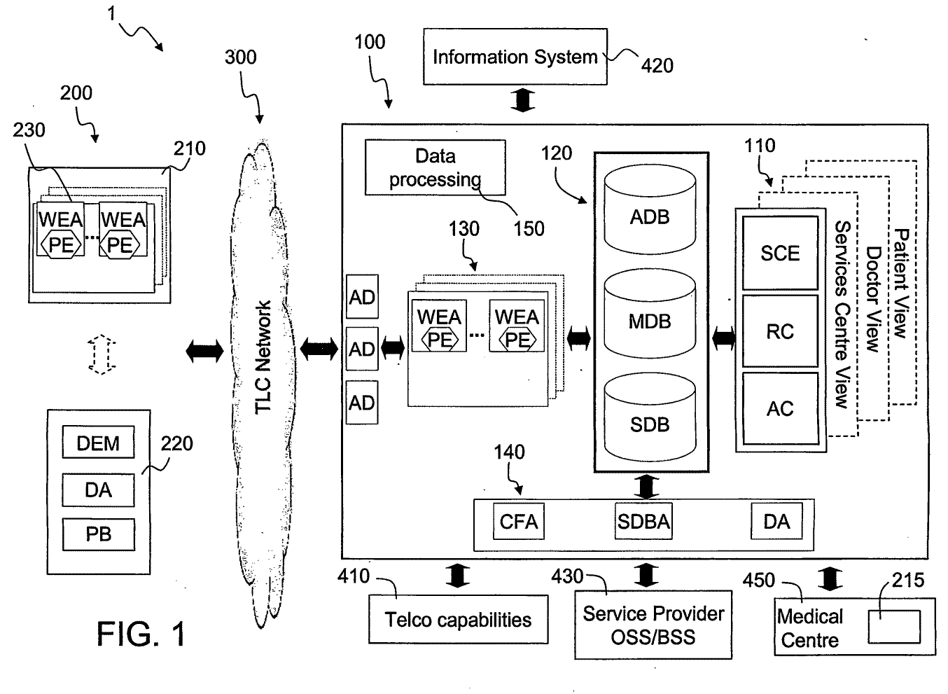

In a preferred implementation, the system of the present invention, designated as a whole with 1 in FIG. 1, comprises a central platform 100, a local system 200 and at least one telecommunications network 300 connecting the local system 200 to the central platform 100. Even if in the present invention reference will be made to a single local system 200 for an easy representation, it is clear that the invention can be applied to any number of local systems, that can be managed by the same central platform.

The central platform 100 comprises the following components:

a Graphic Representation System 110;

a Data Storage System 120;

a Workflow Execution Environment 130; and

a Platform Control Environment 140.

The Graphic Representation System 110 comprises:

a Service Creation Environment SCE, namely a software application (or module) that allows defining the workflows in a graphic mode;

a Report Console RC, namely a software application that allows graphically displaying data collected from patients; this console can for example be a web-based console (therefore accessible also through Internet) or a standalone graphic type of user interface (GUI);

an Administrative Console AC, namely a software application that allows administering and monitoring the platform through a graphic console.

The functionality of these three components can be made available on dedicated web access gateways by defining ad hoc views, for example:

a Services Centre View, available to third parties that use the platform to offer their own services;

a Doctor View, for displaying and configuring patients/cured people data by the doctor; and

a Patient View, for displaying and configuring their own data by patients.

The Data Storage System 120 comprises the following set of databases:

a workflow and model database SDB, to store all workflow and model descriptions (namely the layout of data treated by workflows, for example measures, clinical protocols, patient information) of treated data, that are used by platform components for managing healthcare and wellness services;

an administrative database ADB, for storing administrative data of cured people, doctors, third parties, used devices, subscribed services, subscribed polices and SLA (Service Level Agreement) and specific services data; and

a measure database MDB, for storing measure-related data (for example oximetry measures, electrocardiogram (ECG) layouts, blood exam results, alarms for parameters exceeding thresholds), obtained as described below.

The Workflow Execution Environment 130 is a runtime environment that houses Workflow Executor Agents WEA and manages their life cycle and operations. Each WEA agent contains a Process Engine PE adapted to execute workflows, possibly even more than one simultaneously (in a number that depends on the workload and used hardware resources configuration).

The platform 100 also comprises components called Adapters and designated as AD, adapted to interface the Workflow Execution Environment 130 with the network 300 (depending on different transmission protocols used therein), thereby making the use of different transmission channels “transparent”.

The Platform Control Environment 140 is a runtime environment that houses three types of agents:

a Configuration Agent CFA, responsible for controlling the life cycle of platforms and in particular responsible for activating, controlling and deploying agents; in particular, the CFA offers the following functionalities:
“startup platform”, using a configuration in which agents and their distribution are specified;
“shutdown platform”, through the shutdown of individual agents;
activation of Workflow Execution Environment 130 (“start container”);
end of Workflow Execution Environment 130 (“shutdown container”);
startup of a new agent on an existing execution environment (“startup agent”);
end of an agent on an execution environment (“shutdown agent”);
display of agent attributes and possibility of modifying some parameters (for example “pool size”, namely the number of simultaneously executable workflows);

a database managing agent SDB, designated with SDBA, whose task in particular is making available the contents of the SDB database and validating the workflows; and

a workflow Deployment Agent DA, adapted to receive the workflows validated by the SDBA agent and perform the deploying of such workflows.

The central platform 100 can further be adapted to interact with external systems for receiving and sending necessary information for delivering the services. Interactions are for example possible with the following systems:

a telecommunications functionality (Telco capabilities) system 410, adapted to provide data related to functionalities and applications made available by infrastructures and systems of telecommunications networks, such as for example location data, user presence and profile;

an information system of the healthcare type 420, adapted to connect with information systems in an healthcare environment;

Service Provider OSS/BSS (Operation Support System/Business Support System) 430, that for example performs service billing if the service is offered to third parties;

an assistance centre in a medical environment (Medical Centre) 450 (for example a health assistance centre, a clinic, a consultancy centre, etc.), adapted to provide a specialist service (for example medical or food consultancy) through the system 1.

The central platform 100 further comprises a data processing module 150, typically a COTS (Commercial Off The Shelf) software, for analysis clinical data, reports (for example electrocardiogram reports), etc.

The local system 200 comprises one or more sensor devices 220 (herein below simply called sensors), to be used by users (for example patients), and one or more terminal devices 210 (herein below simply called terminals), to be used by the same users or specialised personnel (for example doctors in the same place of patients), adapted to interact with sensors 220 and to communicate with the network 300; The terminals 210 will be identified below also as “nodes” of the local system. Also the medical centre 450 can comprise terminals 215, to be used by specialist personnel, adapted to communicate with the platform 100.

Typically, a user will have a kit of sensors 220 and a terminal 210 available. Alternatively, according to the type of service, the terminal 210 could be used by nurses or medical personnel in the same seat where the user is present (for example an hospital).

The sensors 220 can for example be electro-medical devices DEM, environmental devices DA or “panic buttons” PB. Moreover, the sensors 220 can be integrated in the terminals 210, or be separate devices. In particular, the sensors 220 can be integrated or associated with more complex machines or instruments, such as for example wellness machines (tapis roulants, steps, cyclettes).

Terminals 210 and sensors 220 are able to interact one with the others for exchanging data and information (for example measure data, or information provided by doctors). If the sensors 220 are physically separate from the terminals 210, the connection can occur for example through a Bluetooth or WIFI, irda, zigbee, wibree interface, or radiofrequency proprietary (“rf proprietary”) solutions.

In an application of the present invention, the kit of sensors 220 comprises sensors that are able to detect biomedical parameters (for example: pressure, temperature, oxymetry, glycaemia, heart rate, weight, percentage of body fat). Preferably, the kit of sensors 220 also comprises sensors that are able to detect environmental parameters (for example: environmental temperature, humidity, height).

Terminals 210 and terminals 215 can be stationary terminals (for example personal computers, stationary videotelephones, medical equipment) or mobile terminals (for example PDA, smartphones, laptops, portable electro-medical apparatuses). The terminals 210 has also the Device Gateway functionality, allowing the functionalities implemented by sensors to access the network 300.

The communication between terminals 210 and platform 100 can be performed for example by using a transmitting channel of the GPRS or SMS type. Adapters AD make the use of different transmitting channels transparent in the communication between terminals 210 and platform 100. In such communication, the terminals 210 transmit to the platform 100 the data coming from the sensors 220 so that such data can be processed according to the service logic, for example through WEA agents, and be stored in the measure database MDB.

Preferably, also the terminals 210 comprise a Workflow Execution Environment 230, similar to the already described one, namely comprising at least one WEA agent provided with a Process Engine PE, for executing workflows. Conveniently, if terminals 210 have inside them a workflow engine PE, measure data are locally processed (in terminals themselves) by executing a service logic (implemented as workflow).

Terminals 210 are moreover provided with a graphic console, for example a web-based console or a stand-alone GUI.

Possibly, also the terminals 215 of the medical centre 450 can comprise a similar workflow environment.

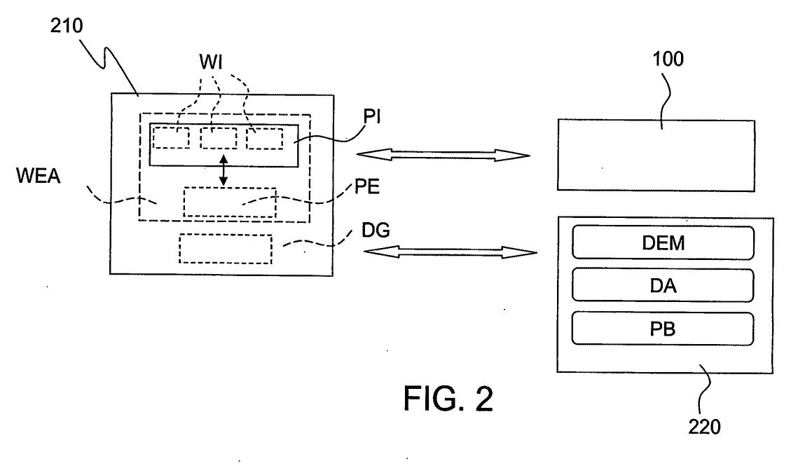

In detail, as shown in FIG. 2, a terminal 210 preferably includes the following components:
an agent WEA, adapted to communicate with the server part of the platform 100 and comprising in turn a graphic interface PI (Personal Interface) through which the user can interact with the workflow, a set of Widgets WI, namely of graphic components of interface PI, and a process engine PE for executing workflows;
a device gateway DG, namely a component that is interfaced with sensors 220 in a wired or wireless mode (for example through the Bluetooth protocol) in order to find data related to sensor 220 measures and context information (for example environmental information, patient location, time of the day, type of used terminal), and possibly notify the alarms.

The components of platform 100 and their functionality can conceptually be grouped into three levels: a first services creation level, a second services provisioning level, and a third services execution level.

At first level (services creation), the major platform component is the Services Creation Environment SCE, through which it is possible to define service logics through workflows using, for example, the XPDL standard.

At second level (services provisioning), the major components are the database SDB, the agent SDBA, the adapter AD and the Administrative Console AC. This level allows making available for executing the workflows defined through the environment SCE. With reference to FIG. 10, the functionalities that can be accessed through the Administrative Console AC and related to this level are:
a Service Download, namely finding a suitable workflow from the Data Storage System 120, in particular from workflow and model database SDB, and its downloading in the Services Creation Environment SCE through the agent SDBA for managing the database SDB;
a Service Upload, namely the insertion of a new workflow in the workflow and model database SDB from the Services Creation Environment SCE through the agent SDBA;
a Service Validation, namely the formal check, through the agent SDBA, that a workflow already inserted in the environment SDB is executable;
a Service Deployment, namely making available a validated workflow for its execution in Workflow Execution Environments 130 and 230;
a Service Removal, namely the removal of a workflow already inserted in the SDB environment.

The third level (services execution) represents the step of deploying services by the platform. Such level is arranged for the real execution of previously defined workflows (in the first level), and already uploaded in the SDB environment, validated and deployed (in the second level). The major components of such level are the Workflow Executing Agents WEA, that can be deployed on many Workflow Execution Environments (130, 230), that can in turn be deployed, in addition to the platform 100, on different nodes 210 of the local system 200 and on possible terminals 215 of a medical centre 450.

According to an aspect of the present invention, the system 1 user (for example the patient or the doctor) can interact, through the graphic console PI of its own terminal 210. The workflow being executed on the platform 100 or on the terminal 210 is able to process measures coming from sensors 220. If the workflow is being executed on the platform 100, or is being executed on the terminal 210 but it is necessary to communicate information to terminals of other users (for example to a terminal 215), it is possible to send asynchronous notifications (from platform 100 to terminal 210 or from terminal 210 to other terminals, such as terminals 215) according to modes that can be configured depending on the implemented service logic. As an example, notifications can be sent through e-mail, SMS, or phone calls, using the suitable adapter AD. The possible use of Telco services as locating and presence services can allow giving a context to transmission of notifications to users (for example on a fixed telephone if the user is at home, or on a mobile telephone if he is outside).

The system 1 of the present invention allows for example implementing the following types of service (the list is an example and is not exhaustive) within healthcare and wellness environments:
“home caring” for home assistance when performing a medical therapy;
support to doctor activities during hospital or first aid assistance activity;
teleassistance for elderly patients or patients affected by invalidating pathologies;
teleconsulting and medical cooperation;
telemonitoring for patients affected by chronical or temporary disabling pathologies;
tele-first aid and teleassistance for people that are particularly subjected to illnesses or accidents, such as elderly or disabled people or children;
post-surgery tele-rehabilitation;
drug therapy management;
work force management in hospital environments or for home activities;
telemonitoring and telemetry of sports exercises in gymnasiums or open environments (such as sports fields or athletic paths), with control of physical activity behaviour;
telemonitoring services for elderly patients affected by disabling pathologies, based on environmental parameters and on patient measures and on subject interaction with the environment, performed through environmental wireless or wired sensors.

Some of these services will be described below, as an example.

According to the present invention, in these application environments, workflows are used for:
defining and implementing the service logic (namely the application logic performed when providing the healthcare or wellness service);
defining and implementing care protocols associated with every single patient;
defining and implementing the set of activities that realise a decisional support system to be used by professionals in the field (for example doctors, nurses, pharmacists) when analysing and compiling reports.

Interactions with workflows allow notifying alarms (in case, for example, of vital parameters exceeding a threshold), notifying reminders (in case, for example, of assumption of drugs or the need of performing measures), and sending to the patient all necessary information to comply with the care protocol (for example as regards composition of meals). The data displaying console RC moreover allows the doctor (and the patient) to find and analyse measures performed during the measuring process (and stored in the measure database MDB).

Implementing a service requires different steps. Typically, in a first step, a Services Centre operator defines on the platform 100, by using the environment SCE, a set of workflows implementing the service logic, and in particular a workflow that defines the step of activating the service and the specific workflows of the service itself.

A generic procedure for activating a service, common to all types of service, is described below.

Following the purchase of a service by a user (for example by subscription through internet), the system manager inserts a series of starting configuration data (about user and required service) in the Administrative Database ADB. The user then performs all service activation operations by operating from the (stationary or mobile) terminal 210 or through internet.

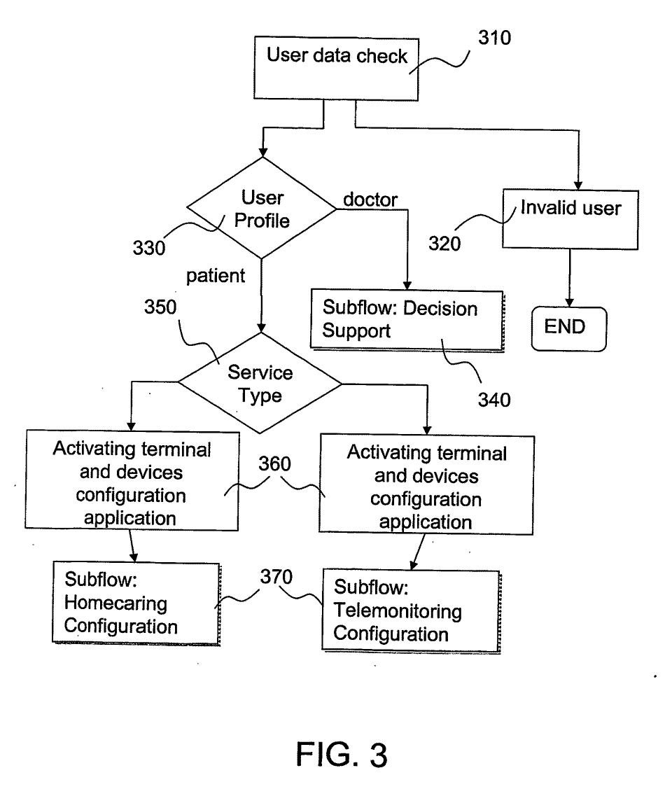

The request sent by the user is received by the platform 100 through an adapter AD (for example an adapter AD for https in case of request through internet) and sent to a Workflow Execution Agent WEA of the platform 100. Such agent WEA activates on its own process engine PE an activation workflow service for the user, that performs the following activities, also schematised in the flow diagram of FIG. 3:
the user profile (310) is first verified by consulting the administrative database ADB;
if the user is not valid (320), for example in case of wrong credentials or service not active any more, the workflow is ended;
if the user is valid, its profile is checked (330) on the administrative database ADB;
if the profile is Doctor, a subflow of the Decisional Support type is run (340) to help the doctor to define therapies with synthesis about the patient health state and with suggestions about possible changes;
if the profile is Patient, the type of requested service is verified (350) by consulting the administrative database ADB;
according to the type of required service, for example of the homecaring type or of the telemonitoring type, the Workflow Execution Agent WEA performs the activation of a related application (360) (stored in the administrative database ADB) for the configuration of one or more terminals and one or more sensors through a suitable adapter AD, and on the terminal 210 a related subflow is run (370), for example of the Homecaring Configuration or Telemonitoring Configuration type.

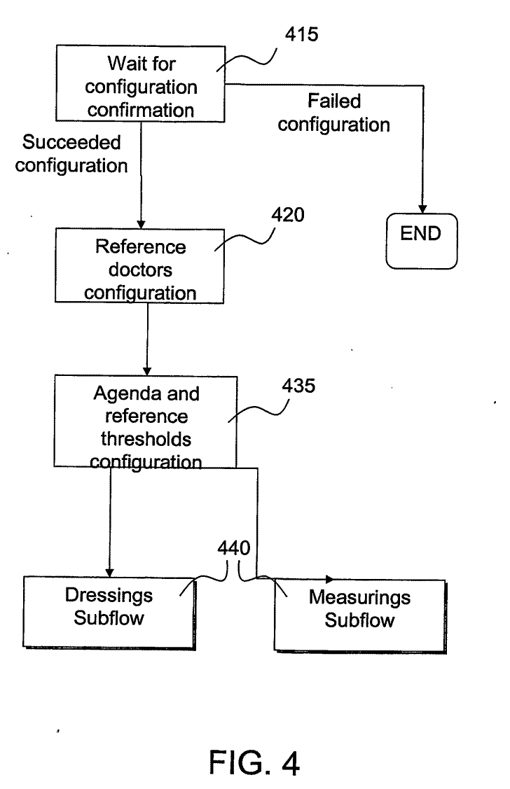

With reference to FIG. 4, the telemonitoring service configuration subflow (Telemonitoring Configuration) initially waits that the configuration of terminal 210 and kits of sensors 220 available to the patient is ended (415). Such configuration can include, for example, the activation on terminal 210 of the agent WEA and the gateway DG towards medical devices, and the Bluetooth pairing between gateway DG and sensors 220.

If the configuration step is not successfully ended, the subflow is ended.

If the configuration is successfully ended, the confirmation of the performed configuration is sent to the subflow through a communication between Workflow Execution Environment 230 on terminal 210 and agent WEA of the platform 100 on which the subflow runs, through a suitable adapter AD.

The configuration subflow then goes on with the following steps:
configuration of reference doctors for the patient (420) within the administrative database ADB (by an operator or automatically if pre-assigned);
configuration of Medications and Measures agendas that allow the reference doctor to plan measures and drug administrations that the patient must perform during the day and the reference thresholds for measures that will be performed by the patient (435);
activation in a parallel and asynchronous way of two Medications and Measures subflows for managing patient medications and measures (440).

These subflows, according to the service configuration, can be executed locally on platform 100 or remotely on patient terminal 210.

The two subflows run at the end of the configuration are those that practically implement the service required by the user and are marked by the interaction with the user itself.

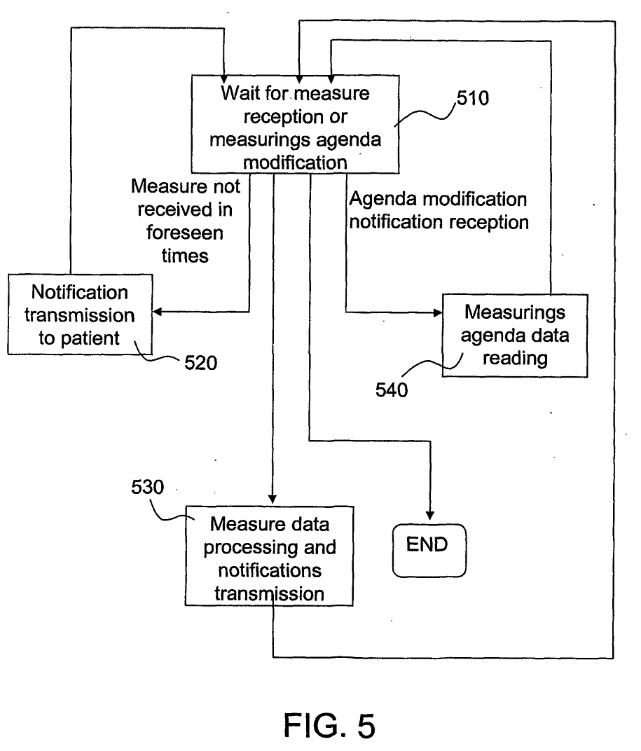

The Measures subflow is described below with reference to FIG. 5. The subflow performs the following steps:
initially, the subflow remains waiting (510) for receiving patient measures or modification notifications from measures agenda;
if the measure is not received within the foreseen times, a notification is sent to the patient (520), for example through SMS, by using the suitable adapter AD according to the service configuration;
if the measure is received within the foreseen times, the subflow processes the data (530), enters them in the measure database MDB and, if provided by the service configuration, sends notifications to the doctor for measures that exceeded the pre-established reference thresholds for the patient, for example through SMS and/or through a suitable signalling on the data displaying console RC;
as regards the measures agenda, the subflow initially finds in the administrative database ADB the measures agenda (previously entered at configuration level and/or modified by the doctor) and self-configures depending on such agenda; in case of reception from workflow of a measures agenda modification notification that allows the doctor to modify the agenda, the subflow is reconfigured depending on new parameters (540);
the END block represents the measures deactivation.

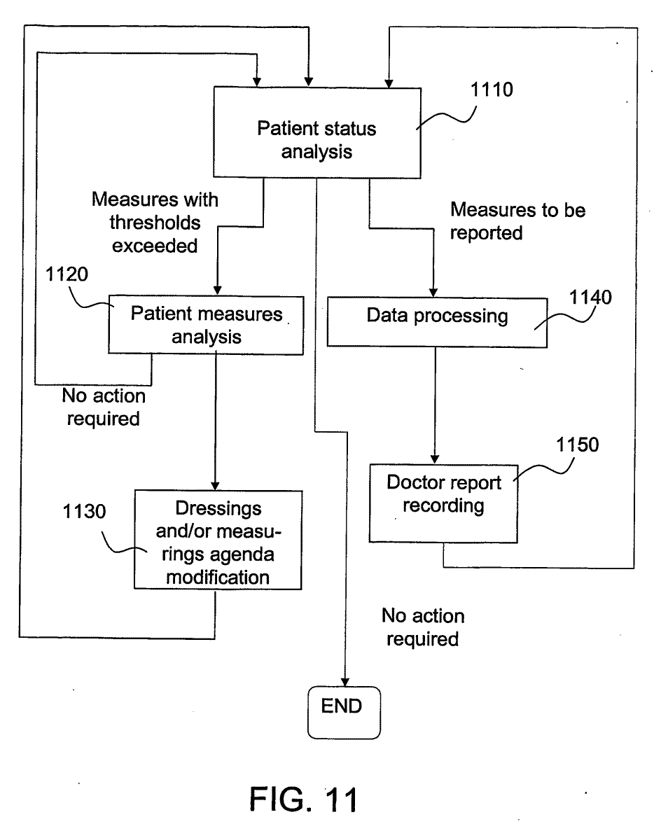

The Decisional Support block 340 of FIG. 3 is described below with reference to FIG. 11.

The doctor accesses the patients information monitored by him and verifies the global patient state verifying measure data and associated agendas (1110).

If there are measure values exceeding a threshold, the doctor analyses the global behaviour of measures performed by the patient through a data analysis software and possibly queries and consults similar historical data as support for actions to be performed (1120). If he deems it suitable, the doctor modifies the patient therapy and the medications agenda (1130).

If there are measures requiring filling of reports, the doctor analyses the measure data with the automatic analysis and report filling software (1140) and, depending on performed processing and measure, writes the report (1150) that will be recorded in the measures database MDB.

Supposing that the telemonitoring service is dedicated to patients with chronic pathologies (for example diabetic, cardiopatic, asthmatic people, etc.), the service allows periodically communicating (as provided in step 530) to a medical centre 450 the value of some measured parameters (for example glycaemia, blood pressure, weight, blood saturation, daily diet, etc.). The caring doctor can thereby perform the analysis of received measures, monitor the behaviour of a possible therapy and activate possible corrective actions (ex. insulin dose or diet variation).

The platform 100 is adapted to execute an instance of the previously described workflow for every patient that has activated the service. Moreover, at any time when deploying the service, the telemonitoring workflow can be modified by a Service Centre for adapting it to new requirements.

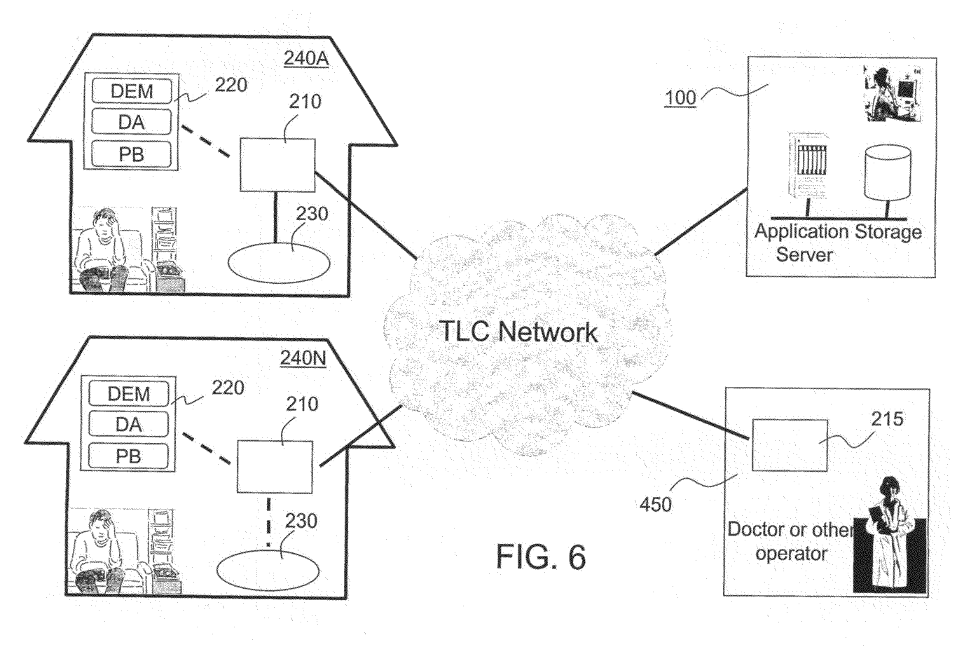

As previously mentioned, a further service that can be deployed is the home caring service for home assistance when performing a medical therapy. Such scenario is shown in FIG. 6, where a plurality of terminals 210 can be seen, associated to respective kits of sensors 220 and to respective devices for controlling environmental parameters (for example a conditioner) 230; all these devices are typically used by respective patients in respective houses 240A, . . . ,240N. The connection between devices for controlling environmental parameters 230 and terminals 210 can be of the wired or wireless type. The system also comprises the network 300, the platform 100, and a medical centre 450 in which a further terminal 215 is arranged to be used by a doctor. Wired connections are represented with a continuous line, while wireless ones with a dashed line.

In such scenario, doctor and patient agree about a therapy, that for example includes: pharmacological dosing (for example the value of insulin to be assumed), diet, planning of measures (for example glycaemia, blood pressure, weight, etc.). The doctor, by using the Services Creation Environment SCE of the platform 100, accessible through the console RC, and with the help of the Services Centre 440, defines the workflow corresponding to the specific care plan for the patient. The thereby arranged workflow is made available through a Services Provisioning process as previously described.

The step of activating the service is analogous to what has been previously described. In this scenario, the terminal 210 used by the patient (for example a cellular phone) performs both the function of Gateway DG and the function of platform node with Workflow Execution Agent WEA. Moreover, processing of data measured by sensors 220 (electro-medical devices, environmental devices, etc.) is performed locally without the need of involving the rest of the platform, exploiting the terminal computation capability.

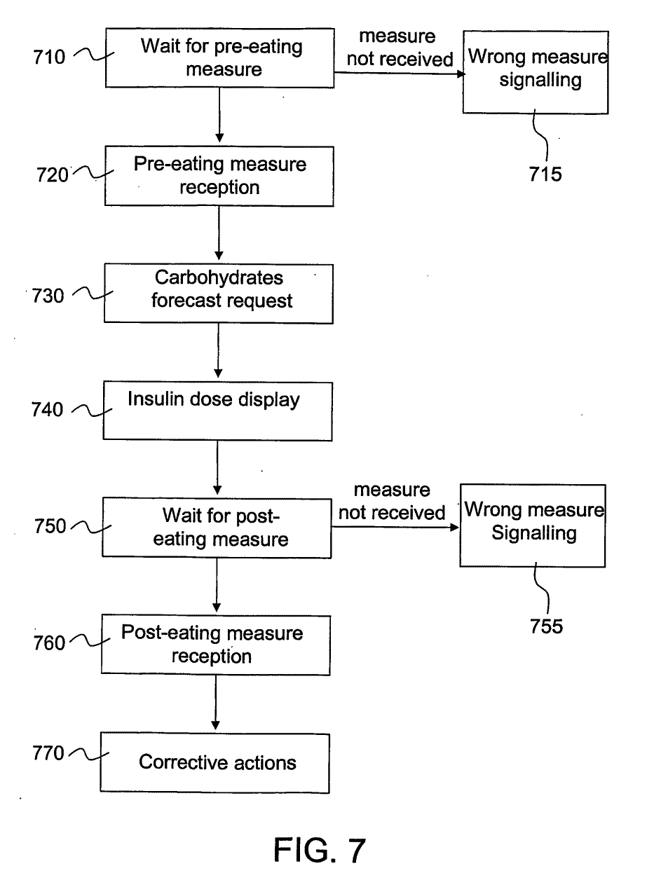

FIG. 7 shows a possible workflow of a home caring service for diabetic patients, in a scenario as shown in FIG. 6. The patients are equipped with sensors 220 of the medical type (DEM) for measuring glycaemia and user terminals 210 that are able to execute the workflow and to interact with medical devices 220. In the workflow, computation logics are implemented for insulin dosing depending on measures of glycaemia values and the indication by the patient about foreseeing macro-nutriments of the meal that will be assumed. In detail, the workflow performs the following steps:
the workflow being executed on the patient terminal 210 remains waiting for receiving the pre-meal glycaemia measure (710);
if the measure does not arrive within a pre-established time, the workflow takes care of generating a wrong measure message for the patient (715);
when the measure is performed through the DEA sensor (a glucose meter in the specific case), measure data are sent through bluetooth by the DEA sensor to terminal 210 through the Gateway DG (720);
the workflow remains then waiting for receiving the forecast of division of meal macro-nutriments (for example forecast of carbohydrates), that the patient will have to enter through the PI interface of the agent WEA being executed on terminal 210 (730);
on the patient terminal 210, the indication of the insulin dose to be assumed is then displayed (740), established depending on previously processed data;
the workflow then remains waiting for receiving the post-meal glycaemia measure (750);
if the measure does not arrive within a pre-established time, the workflow takes care of generating a wrong measure message for the patient (755);
when the measure is performed through the DEA sensor, the measure data are again sent through bluetooth by the DEA sensor to terminal 210 through the Gateway DG (760);
depending on post-meal measure results, possible corrective actions will moreover be signalled to the patient (770).

As already previously described, the workflow defining the patient monitoring protocol can also interact with sensors of the DA (environmental devices) type that measure environmental parameters (such as temperature and humidity inside the house, barometric pressure, altitude, etc.), devices equipped with Panic Button PB and devices for controlling environmental parameters 230 (for example a conditioner for changing a room temperature). In this latter case, the corrective actions present at the end of the workflow (770) can comprise an automatic interaction between terminal 210 and devices 230 to adjust environmental conditions according to pre-established rules linked to patient conditions, for example by lowering or increasing temperature and/or humidity.

The doctor can anyway change at any time the patient care protocol by using services provisioning functionalities of the platform 100, previously described.

The present invention moreover allows, as already previously mentioned, to perform services supporting the doctor. The doctor can be helped when assisting the patient through a workflow that, being executed on its own terminal, operates as his assistant by analysing data received from patients and performing a first diagnosis. The workflow moreover can activate evolved data analysis software automatically for the following doctor analysis.

The workflow in particular is adapted to send notifications to the doctor upon receiving (from the sensor device 220) vital patient parameters that are out of range, to suggest a change of therapy or telemonitoring parameters (for example a measure frequency, or a warning setting modification), and to perform the analysis of received measures by activating third parties' software (for example graphic electrocardiogram processing).

The present invention moreover allows deploying services related to the wellness sector, such as for example telemonitoring of vital parameters (ex. heart rates, breathing frequency) during sports training, daily diet management, and telemonitoring of daily calories consumption. For example, the use of workflows allows analysing, for every user, services to suit the daily diet to the daily calories consumption, or to make available for an athlete the value of his own bio-physical data when training.

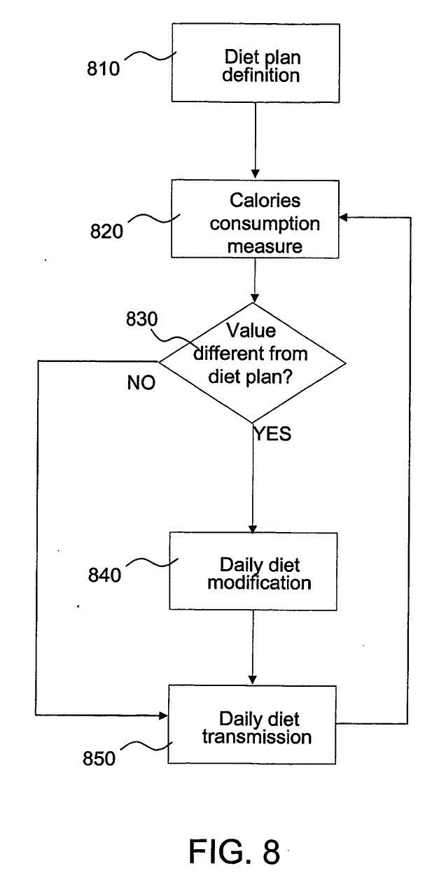

Herein below a service is described for defining the diet depending on the daily calories consumption, and therefore the performed physical activity. The service, for every user, comprises the definition of a “diet” plan by a dietist that, for every day of the week, provides for the type of foods and their related amounts to be assumed and the foreseen calories consumption; the telemonitoring of daily calories consumption through a device worn by the user; and the daily transmission of correct diet information to the user. This service is performed by using the workflow shown in FIG. 8, being executed on the user terminal 210.

As starting data, the diet plan is set (810) provided by the doctor and stored in the administrative database ADB. The workflow being executed remains then always waiting for receiving measures about calories consumption. Such measures can be performed at pre-established time intervals. The terminal 210 is arranged for interacting through the gateway DG with sensor 220 that measures the calories consumption and that is worn by the user. Depending on an agenda established at a certain time of the day, the received measures will be processed and the diet plan will be updated and made available to the user on the terminal. More in detail, the workflow verifies whether the measured calories consumption (instantaneous or integrated) is compatible with the current diet plan (830). If the calories consumption value falls within the range provided by such plan (output NO from block 830), the workflow goes on by proposing a daily diet to the user (840). If instead the calories consumption value is outside the range provided by the diet plan (output YES from block 830), the workflow suitably modifies the diet plan (840) taking into account the new calories consumption and sends it to the user (850). The workflow the returns waiting for receiving a new measure.

A further possible service is the telemonitoring service for elderly patients affected by disabling pathologies. Such service is aimed to structures for health assistance of not self-sufficient elderly people such as for example the RSA (Residenze Sanitarie Assistite—Assisted Health Residences) in which the elderly person is provided with a continuous (day and night) assistance by responsible personnel. For such purpose the structure personnel is provided with terminals 210, of the stationary or mobile type.

In this service, a set of environment sensors DA are used, pre-arranged in the structure rooms of interest, that allow for example monitoring temperature, air quality, light and one or more DEM sensors being present on the patient, that allow for example monitoring hearth rate, body movements, and location.

All signals coming from sensors are collected in the measure database MDB and the structure personnel has access to data through the doctor/services centre operator view and can therefore keep structure and housed patients under control.

The service operates as follows. By using the Services Creation Environment SCE, the Services Centre 440 defines a set of workflows that implement the service logic and in particular the workflows implementing the various emergency and intervention situations on the assisted person.

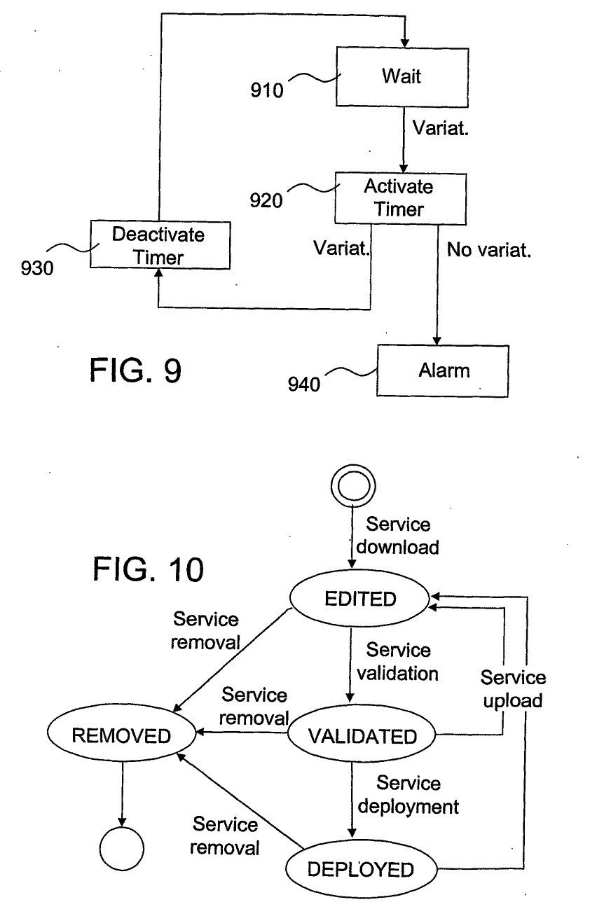

For example, it is possible to locate a critical situation by a patient that remains in bathrooms during the night for more than 30 minutes stationary with the light on. Such situation is managed with a portion of workflow shown in FIG. 9 and described below. Such portion of workflow uses DA sensors that measure lighting of different rooms and DA sensors that measure patient movement and location.

Variations of these sensors are traced in the measure database MDB and should a situation occur with presence of a patient in a bathroom during the night with light on and no movement signal, a timer is set in the workflow, depending on information stored in the administrative database ADB. Upon expiry of the maximum provided time, if no variation occurred, an alarm is signalled to the operator.

In this case the workflow is being executed on the platform and uses both environmental measures and measures related to the patient by combining them together for detecting critical situations.

In detail, the portion of workflow operates as follows:
the workflow periodically verifies (at very short intervals) the three parameters of location, movement and lighting and compares them with the three statuses representing the situation deemed as critical, namely location=bathroom, movement=unmoving and light=on; the workflow remains waiting till the three statuses simultaneously occur (910);
when the three above statuses occur, the workflow activates a timer for a pre-established time (ex: 30 minutes) and remains waiting either for a variation of one of the three parameters or for the timer time-out (920);
if there is a variation of one of the statuses, the timer is deactivated (930) and the workflow returns to the starting waiting status;
if the pre-established time expires without a status variation, an alarm signal is activated for the operator (940).

1-32. (canceled)

33. A method for performing a teleassistance service, comprising:
executing a measure of at least one biomedical parameter on a service user; and
executing, through a software agent, at least one workflow associated with the service and defining a process interactive with the measure execution.

34. The method according to claim 33, comprising transmitting information related to a result of the measure to a remote system through a telecommunications network.

35. The method according to claim 33, further comprising providing the user with a feedback based on a result of the measure.

36. The method according to claim 35, wherein the software agent is in a terminal.

37. The method according to claim 35, wherein the software agent is in a remote system.

38. The method according to claim 33, comprising the preliminary steps of defining the workflow in order to implement a service logic, and of storing the workflow in a database.

39. The method according to claim 36, comprising receiving a service request by a user, and executing, in reply to the service request, a service activation workflow in a software agent, and wherein executing an activation workflow comprises selecting the workflow associated with the service among a plurality of available workflows, depending on information contained in the service request.

40. The method according to claim 39, wherein executing the activation workflow comprises transmitting the selected workflow to the terminals.

41. The method according to claim 39, wherein executing the activation workflow comprises configuring the terminal to adapt the terminal for executing selected workflow.

42. The method according to claim 41, wherein the software agent is in the terminal and configuring the terminal comprises activating the software agent in the terminal and activating a connection between the terminal and a sensor.

43. The method according to claim 33, further comprising the step of executing a measure of at least one environment parameter related to an environment in which the user is located, and defined by the workflow being interactive also with the execution of the measure of the at least one environment parameter.

44. The method according to claim 33, further comprising the step of executing a user location measure, and defined by the workflow being interactive also with the execution of the location measure.

45. A system for performing a teleassistance service, comprising:
a central system capable of controlling and managing the service;
a local system capable of executing the service; and
a telecommunications network capable of being adapted to communicate the central system with the local system,
wherein the local system comprises at least one sensor capable of being adapted to perform measures of at least one biomedical parameter on a user and a terminal capable of being adapted to communicate with the sensor to receive information related to the measures;
and wherein at least one of the terminal and the central system comprises a software agent provided with a process engine capable of executing workflows, said agent capable of being adapted to interact with the sensor with executing workflows.

46. The system according to claim 45, wherein the terminal is capable of being adapted to transmit said information to the central system through the telecommunications network.

47. The system according to claim 45, wherein the terminal comprises said agent and a graphic interface through which the user can interact with the workflows.

48. The system according to claim 45, wherein the terminal comprises a device gateway for communicating with the sensor.

49. The system according to claim 45, wherein the terminal and the sensor are capable of being adapted to mutually communicate through a wireless connection.

50. The system according to claim 45, wherein the central system comprises a graphic representation system capable of creating workflows.

51. The system according to claim 45, wherein the central system comprises a data storage system for storing workflows and results of said measures.

52. The system according to claim 45, wherein the central system comprises a plurality of workflow executing agents, each agent comprising a process engine for executing workflows.

53. The system according to claim 45, wherein the central system comprises a plurality of adapters capable of interfacing a plurality of workflow executing agents with the telecommunications network, depending on transmission protocol.

54. The system according to claim 45, wherein the central system comprises a workflow deploying agent.

55. The system according to claim 45, wherein the local system comprises at least one environment sensor capable of being adapted to measure an environment parameter, said agent capable of being adapted to interact with the environment sensor when executing workflows.

56. The system according to claim 45, comprising at least one further terminal capable of being adapted to communicate with said terminal through the central system and the telecommunications network.

57. The system according to claim 45, wherein the sensor is integrated in the terminal.
